(19) United States
(12) Patent Application Publication
(10) Pub. No.: US 2026/0225430 A1
(43) Pub. Date: Aug. 6, 2026

(54) VEHICLE HEAT MANAGEMENT SYSTEM

(71) Applicant: Hanon Systems, Daejeon (KR)

(72) Inventors: Jun Min LEE, Daejeon (KR); Markel IBARRA FERNANDEZ, Daejeon (KR); Sung Jin KIM, Daejeon (KR); Young In KIM, Daejeon (KR); Yong Sik KIM, Daejeon (KR); Hyeon Gyu KIM, Daejeon (KR)

(73) Assignee: Hanon Systems, Daejeon (KR)

(21) Appl. No.: 19/143,689

(22) PCT Filed: Oct. 18, 2023
(86) PCT No.: PCT/KR2023/016122

§ 371 Date: Jun. 26, 2025

(30) Foreign Application Priority Data
Dec. 27, 2022 (KR) 10-2022-0185210

(51) Int. Cl. B60H 1/32; B60H 1/00; B60H 1/22

(52) U.S. Cl. CPC B60H 1/32281; B60H 1/00278; B60H 1/2221; B60H 1/3213

(57) ABSTRACT

A vehicle heat management system includes a refrigerant circulation line configured to generate heat or cold air depending on the direction of flow of a refrigerant, a heater core-side coolant circulation line configured to transfer the heat of the refrigerant generated in the refrigerant circulation line to a vehicle interior-side heater core to heat a vehicle interior, a battery-side coolant circulation line configured to circulate a coolant to a battery, a water-cooled heat exchanger configured to transfer the heat of the refrigerant generated in the refrigerant circulation line to the coolant in the heater core-side coolant circulation line, an electric heater configured to heat the coolant in the heater core-side coolant circulation line, and a coolant flow control part configured to circulate the coolant in the heater core-side coolant circulation line.

### TECHNICAL FIELD

The present invention relates to a vehicle heat management system, and more particularly, a vehicle heat management system configured to warm a battery using the heat generated during a refrigerant circulation process in an air conditioner, thereby reducing the frequency of using an electric heater to warm the battery, and preventing excessive energy consumption, and configured to heat the vehicle interior and warm the battery with a single electric heater, thereby reducing the number of electric heaters and excessive energy consumption, and improving the fuel efficiency and electric power efficiency of a vehicle.

### BACKGROUND ART

Examples of eco-friendly vehicles include an electric vehicle, a hybrid vehicle, and a fuel cell vehicle (hereinafter collectively referred to as “vehicle”).

Such a vehicle is equipped with a vehicle heat management system.

As shown in FIG. 1, the heat management system includes an air conditioner 10 for cooling and heating the interior of a vehicle, and a water-cooled cooling device 30 for cooling specific objects of a vehicle to be cooled, for example, electrical components such as a battery 20 and an electrical component module 22.

The air conditioner 10 is of a heat pump type and includes a refrigerant circulation line 12. The refrigerant circulation line 12 includes a compressor 12a, a high-pressure side indoor heat exchanger 12b, an heat pump mode expansion valve 12c, an outdoor heat exchanger 12d, a plurality of air conditioning mode expansion valves 12e, and a plurality of low-pressure side indoor heat exchangers 12f.

The low-pressure side indoor heat exchanger 12f includes a vehicle interior cooling heat exchanger 12f-1, and a battery cooling chiller 12f-2 (hereinafter referred to as “chiller”), which are installed in parallel with each other.

This refrigerant circulation line 12 opens the heat pump mode expansion valve 12c in an air conditioning mode, so that the refrigerant of the compressor 12a is not depressurized and expanded by the heat pump mode expansion valve 12c, but is circulated in the order of the high-pressure side indoor heat exchanger 12b, the outdoor heat exchanger 12d, the air conditioning mode expansion valve 12e, the low-pressure side indoor heat exchangers 12f, and the compressor 12a.

Through this refrigerant circulation, low-temperature cold air is generated in the low-pressure side indoor heat exchanger 12f, and the generated cold air is delivered to the vehicle interior and the battery, thereby cooling the vehicle interior and the battery.

Furthermore, in a heat pump mode, the heat pump mode expansion valve 12c is turned on to allow the refrigerant to be depressurized and expanded, thereby allowing the refrigerant of the compressor 12a to be circulated in the order of the high-pressure side heat exchanger 12b, the heat pump mode expansion valve 12c, the outdoor heat exchanger 12d, and the compressor 12a.

In addition, through this refrigerant circulation, high-temperature heat is generated in the high-pressure side heat exchanger 12b, and the generated heat is supplied to the vehicle interior to heat the vehicle interior.

Meanwhile, the air conditioner 10 includes a separate electric heater 12g for compensating for the relatively low heat generation performance of the high-pressure side heat exchanger 12b in the heat pump mode.

The electric heater 12g heats the air blown toward the vehicle interior to heat the vehicle interior while operating with the applied electric power when the vehicle interior is initially heated or when the high-pressure side heat exchanger 12b has a low heat generation amount.

The water-cooled cooling device 30 includes a coolant circulation line 32, and the coolant circulation line 32 circulates a coolant between the chiller 12 f-2 of the air conditioner 10 and a specific cooling target, for example, a battery 20 and an electrical component module 22.

Therefore, the cold air generated from the chiller 12f-2 is delivered to the battery 20 and the electrical component module 22, thereby cooling the battery 20 and the electrical component module 22.

In addition, the coolant circulation line 32 also circulates the coolant between a radiator 34, the battery 20, and the electrical component module 22.

Therefore, the waste heat of the battery 20 and the electrical component module 22 is absorbed to the coolant, and the waste heat absorbed to the coolant is dissipated through the radiator 34, so that the battery 20 and the electrical component module 22 can be cooled through the heat absorption and dissipation actions of the coolant.

Meanwhile, the water-cooled cooling device 30 further includes an electric battery heater 36 for preheating and warming the battery 20 under a low air temperature condition.

The electric battery heater 36 is installed on the coolant circulation line 32 extending toward the battery 20, and is configured to heat the coolant circulated toward the battery 20 while being operated by electric power in winter when the charging and discharging performances of the battery 20 are low.

Therefore, the heated coolant can preheat and warm the battery 20, thereby improving the charging and discharging performances of the battery 20.

However, this conventional heat management system heats the vehicle interior with a high-voltage electric heater 12g in winter when the air temperature is low, and preheats and warms the battery 20 only with the electric battery heater 36.

Therefore, there is a disadvantage of high energy consumption, thereby significantly reducing the fuel efficiency and electric power efficiency of the vehicle.

In particular, since the electric vehicle is driven by the electric power of the battery 20, there is a disadvantage that the electric power of the battery 20 is exhausted early when the high-voltage electric heaters 12g and 36, which consumes a lot of energy, are frequently used.

This disadvantage leads to a problem that the vehicle's driving distance is significantly shortened.

### DETAILED DESCRIPTION OF THE INVENTION

### Technical Task

The present invention has been made to solve the above-mentioned problems of the prior art, and it is an object of the present invention to provide a vehicle heat management system capable of preheating and warming a battery using the heat generated during a refrigerant circulation process in an air conditioner.

Another object of the present invention is to provide a vehicle heat management system capable of, by adopting a configuration in which a battery can be preheated and warmed using the heat of a refrigerant in an air conditioner, reducing the frequency of using an electric heater for preheating and warming the battery and consequently preventing excessive energy consumption due to the frequent use of the electric heater.

A further object of the present invention is to provide a vehicle heat management system capable of, by adopting a configuration in which the excessive energy consumption due to the frequent use of the electric heater can be prevented, minimizing the consumption of electric power of a battery and consequently improving the fuel efficiency and the electric power efficiency of a vehicle.

A still further object of the present invention is to provide a vehicle heat management system capable of heating the vehicle interior and preheating and warming the battery with a single electric heater.

A yet still further object of the present invention is to provide a vehicle heat management system capable of, by adopting a configuration in which the vehicle interior can be heated and the battery can be preheated and warmed by a single electric heater, reducing the number of electric heaters.

An even yet still further object of the present invention is to provide a vehicle heat management system capable of, by adopting a configuration in which the number of electric heaters can be reduced, reducing the manufacturing cost, preventing the excessive energy consumption due to the use of multiple electric heaters, and improving the fuel efficiency and electric power efficiency of a vehicle.

### Means to Solve the Task

In order to achieve these objects, the present invention provides a vehicle heat management system, including: a refrigerant circulation line configured to generate heat or cold air depending on the direction of flow of a refrigerant; a heater core-side coolant circulation line configured to transfer the heat of the refrigerant generated in the refrigerant circulation line to a vehicle interior-side heater core to heat a vehicle interior; a battery-side coolant circulation line configured to circulate a coolant to a battery; a water-cooled heat exchanger configured to transfer the heat of the refrigerant generated in the refrigerant circulation line to the coolant in the heater core-side coolant circulation line; an electric heater configured to heat the coolant in the heater core-side coolant circulation line; and a coolant flow control part configured to circulate the coolant in the heater core-side coolant circulation line heated by at least one of the water-cooled heat exchanger and the electric heater toward at least one of the heater core and the battery of the battery-side coolant circulation line according to an air conditioning mode condition.

The coolant flow control part may be configured to, when entering a vehicle interior heating exclusive mode under a heat pump mode condition, circulate the coolant in the heater core-side coolant circulation line heated by at least one of the water-cooled heat exchanger and the electric heater toward the heater core, so that the vehicle interior can be heated by the coolant in the heater core-side coolant circulation line.

The coolant flow control part may be configured to, when entering a vehicle interior heating mode and a battery warming mode simultaneously under the heat pump mode condition, circulate the coolant in the heater core-side coolant circulation line heated by at least one of the water-cooled heat exchanger and the electric heater toward both the heater core and the battery of the battery-side coolant circulation line to heat the vehicle interior and warm the battery with the coolant in the heater core-side coolant circulation line.

The coolant flow control part may be configured to, when entering a battery warming exclusive mode under the heat pump mode condition, circulate the coolant in the heater core-side coolant circulation line heated by at least one of the water-cooled heat exchanger and the electric heater toward the battery of the battery-side coolant circulation line to warm the battery with the coolant in the heater core-side coolant circulation line.

The coolant flow control part may include a parallel connection part configured to connect the heater core of the heater core-side coolant circulation line and the battery of the battery-side coolant circulation line in parallel with respect to the water-cooled heat exchanger and the electric heater, and a valve part configured to control the flow of the coolant so that the coolant in the heater core-side coolant circulation line, which has passed through the water-cooled heat exchanger and the electric heater, can be circulated toward at least one of the heater core and the battery of the battery-side coolant circulation line connected in parallel.

The parallel connection part may include a first connection line configured to introduce the coolant in the heater core-side coolant circulation line, which has passed through the water-cooled heat exchanger and the electric heater, toward the battery of the battery-side coolant circulation line before being introduced toward the heater core, and a second connection line configured to return the coolant in the battery-side coolant circulation line, which has passed through the battery, to the heater core-side coolant circulation line, and the first and second connection lines may connect the battery side of the battery-side coolant circulation line and the heater core side of the heater core-side coolant circulation line so as to form a parallel coolant circulation structure.

The valve part may include a first three-way valve installed at a branch point of the heater core-side coolant circulation line and the first connection line so as to allow introduction of the coolant passed through the water-cooled heat exchanger and the electric heater toward the heater core, or toward the battery of the battery-side coolant circulation line, or toward both the heater core and the battery of the battery-side coolant circulation line, depending on the air conditioning mode condition, a second three-way valve installed at a branch point of the battery-side coolant circulation line and the second connection line so as to allow or prevent return of the coolant passed through the battery to the heater core-side coolant circulation line, depending on the air conditioning mode condition, and a valve control part configured to control the first and second three-way valves according to the air conditioning mode condition to determine whether to allow circulation of the coolant passed through the water-cooled heat exchanger and the electric heater toward the heater core, or toward the battery of the battery-side coolant circulation line, or toward both the heater core and the battery of the battery-side coolant circulation line.

### Effect of the Invention

With the vehicle heat management system according to the present invention, the coolant heated by the water-cooling heat exchanger of the heat pump type air conditioner is circulated toward the battery. Therefore, it is possible to preheat and warm the battery using the heat generated during the refrigerant circulation process in the air conditioner.

Since the vehicle interior can be heated and the battery can be preheated and warmed using the heat of the refrigerant generated in the refrigerant circulation process in the air conditioner, it is possible to reduce the frequency of using the electric heater for preheating and warming the battery and consequently prevent the excessive energy consumption due to the frequent use of the electric heater.

Since the excessive energy consumption due to the frequent use of the electric heater can be prevented, it is possible to minimize the consumption of electric power of the battery and consequently improving the fuel efficiency and the electric power efficiency of the vehicle.

Since the coolant heated by the water-cooled heat exchanger of the heat pump type air conditioner and the electric heater can be circulated toward at least one of the heater core and the battery, it is possible to heat the vehicle interior and preheat and warm the battery using a single electric heater in common.

Since the vehicle interior can be heated and the battery can be preheated and warmed using a single electric heater in common, it is possible to reduce the number of electric heaters, reduce the manufacturing cost, minimize the energy consumption, and improving the fuel efficiency and electric power efficiency of the vehicle.

### BRIEF DESCRIPTION OF THE DRAWINGS

FIG. 1 is a view showing a conventional vehicle heat management system.

FIG. 2 is a view showing a vehicle heat management system according to the present invention.

FIG. 3 is an operation diagram of the vehicle heat management system according to the present invention, showing an operation example when entering a vehicle interior heating exclusive mode under a heat pump mode condition.

FIG. 4 is an operation diagram of the vehicle heat management system according to the present invention, showing an operation example when entering a vehicle interior heating mode and a battery warming mode simultaneously under the heat pump mode condition.

FIG. 5 is an operation diagram of the vehicle heat management system according to the present invention, showing an operation example when entering the battery warming exclusive mode under the heat pump mode condition.

### BEST MODE TO IMPLEMENT THE INVENTION

Hereinafter, a preferred embodiment of a vehicle heat management system according to the present invention will be described in detail with reference to the accompanying drawings. The same components as those of the above-described prior art will be designated by the same reference numerals.

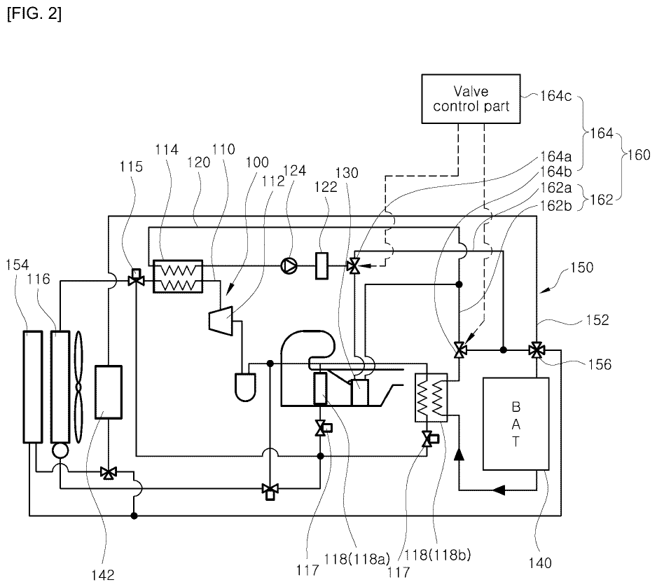

Referring first to FIG. 2, the vehicle heat management system according to the present invention includes an air conditioner 100 for cooling and heating the vehicle interior.

The air conditioner 100 is of a heat pump type and includes a refrigerant circulation line 110 and a heater core-side coolant circulation line 120.

The refrigerant circulation line 110 includes a compressor 112, a high-pressure side water-cooled heat exchanger 114, a heat pump mode expansion valve 115, an outdoor heat exchanger 116, a plurality of air conditioning mode expansion valves 117, and a plurality of low-pressure side heat exchangers 118 installed downstream of the air conditioning mode expansion valves 117.

The low-pressure side indoor heat exchanger 118 includes a vehicle interior cooling heat exchanger 118a and a battery cooling chiller 118b, which are installed in parallel with each other.

The heater core-side coolant circulation line 120 connects the water-cooled heat exchanger 114 of the refrigerant circulation line 110 and the vehicle interior side heater core 130 in a water-cooled manner, and includes an electric heater 122 that heats the coolant by the electric power applied thereto, and a water pump 124 that circulates the coolant between the water-cooled heat exchanger 114, the electric heater 122, and the heater core 130.

In an air conditioning mode, the air conditioner 100 circulates the refrigerant of the compressor 112 in the order of the water-cooled heat exchanger 114, the outdoor heat exchanger 116, the air conditioning mode expansion valve 117, the low-pressure side heat exchanger, and the compressor 112.

Through this refrigerant circulation, low-temperature cold air is generated in the low-pressure side heat exchanger 118, and the generated cold air is delivered to the vehicle interior and the battery 140.

In particular, the cold air generated from the vehicle interior cooling heat exchanger 118a is delivered to the vehicle interior to cool the vehicle interior, and the cold air generated from the chiller 118b is delivered to the battery 140 and the electrical component module 142 to cool the battery 140 and the electrical component module 142.

Furthermore, in the heat pump mode, the refrigerant of the compressor 112 is circulated in the order of the water-cooled heat exchanger 114, the heat pump mode expansion valve 115, the outdoor heat exchanger 116, and the compressor 112.

In addition, in this refrigerant circulation process, the heat of the water-cooled heat exchanger 114 for releasing the refrigerant heat of the compressor 112 is delivered to the coolant in the heater core-side coolant circulation line 120, and the coolant that has received the refrigerant heat can be circulated toward the heater core 130.

Therefore, the heater core 130 releases the coolant heat into the vehicle interior, thereby heating the vehicle interior.

Meanwhile, in the heat pump mode, if the heat generation amount of the heater core 130 is as insufficient as a preset value or less, or if the vehicle interior temperature is as low as a preset value or less, the electric heater 122 of the heater core-side coolant circulation line 120 is turned on to heat the coolant flowing toward the heater core 130.

Therefore, the heat generation amount of the heater core 130 can be increased to increase the temperature of the air blown into the vehicle interior, thereby compensating for the insufficient heat generation amount of the heater core 130 and the low vehicle interior temperature.

Referring again to FIG. 2, the heat management system of the present invention includes a water-cooled cooling device 150 for cooling the battery 140 and the electrical component module 142 by using the cold air generated from the chiller 118b of the air conditioner 100.

The water-cooled cooling device 150 includes a battery-side coolant circulation line 152.

The battery-side coolant circulation line 152 circulates a coolant between the chiller 118b of the air conditioner 100, the battery 140, and the electrical component module 142.

Therefore, the cold air generated from the chiller 118b is delivered to the battery 140 and the electrical component module 142, thereby cooling the battery 140 and the electrical component module 142.

In addition, the battery-side coolant circulation line 152 includes a radiator 154 and circulates the coolant between the radiator 154, the battery 140, and the electrical component module 142.

Accordingly, the waste heat of the battery 140 and the electrical component module 142 is absorbed to the coolant, and the waste heat absorbed to the coolant is dissipated through the radiator 154, and the battery 140 and the electrical component module 142 are cooled through the heat absorption and dissipation actions of the coolant.

Referring again to FIG. 2, the thermal management system of the present invention further includes a coolant flow control part 160 that circulates the coolant in the heater core-side coolant circulation line 120 passed through the water-cooled heat exchanger 114 and the electric heater 122 to at least one of the heater core 130 and the battery 140 of the battery-side coolant circulation line 152 according to the air conditioning mode condition.

The coolant flow control part 160 includes a parallel connection part 162 for connecting the heater core 130 of the heater core-side coolant circulation line 120 and the battery 140 of the battery-side coolant circulation line 152 in parallel with respect to the water-cooled heat exchanger 114 and the electric heater 122.

The parallel connection part 162 includes a first connection line 162a, which is branched from the heater core-side coolant circulation line 120 on the downstream side of the electric heater 122 and connected to the battery-side coolant circulation line 152 on the upstream side of the battery 140, and a second connection line 162b, which is branched from the battery-side coolant circulation line 152 on the downstream side of the battery 140 and connected to the heater core-side coolant circulation line 120 on the downstream of the heater core 130.

The first connection line 162a introduces the coolant in the heater core-side coolant circulation line 120, which has passed through the water-cooled heat exchanger 114 and the electric heater 122, toward the battery 150 of the battery-side coolant circulation line 152 before the coolant is introduced to the heater core 130.

The second connection line 162b returns the coolant of the battery-side coolant circulation line 152 passed through the battery 140 to the heater core-side coolant circulation line 120.

The first and second connection lines 162a and 162b introduce the coolant on the side of the water-cooled heat exchanger 114 and the electric heater 122 toward the battery 140 of the battery-side coolant circulation line 152 before being introduced to the heater core 130, and then return the coolant passed through the battery 140 toward the heater core-side coolant circulation line 120.

Therefore, the battery 140 of the battery-side coolant circulation line 152 can form a coolant circulation structure in parallel with the heater core 130 of the heater core-side coolant circulation line 120.

Referring again to FIG. 2, the coolant flow control part 160 includes a valve part 164 that can circulate the coolant in the heater core-side coolant circulation line 120, which has passed through the water-cooled heat exchanger 114 and the electric heater 122, toward at least one of the heater core 130 and the battery 140 of the battery-side coolant circulation line 152, which are connected in parallel.

The valve part 164 includes a first three-way valve 164a installed at a branch point between the heater core-side coolant circulation line 120 and the first connection line 162a, and a second three-way valve 164 b installed at a branch point between the battery-side coolant circulation line 152 and the second connection line 162b.

Depending on the air conditioning mode condition, the first three-way valve 164a allows the water-cooled heat exchanger 114 and the electric heater 122 to communicate with the heater core 130, or to communicate with the battery 140 of the battery-side coolant circulation line 152, or to communicate with both the heater core 130 and the battery 140 of the battery-side coolant circulation line 152.

Therefore, depending on the air conditioning mode condition, the coolant passed through the water-cooled heat exchanger 114 and the electric heater 122 is allowed to be introduced toward the heater core 130, or to be introduced toward the battery 140 of the battery-side coolant circulation line 152, or to be introduced toward both the heater core 130 and the battery 140 of the battery-side coolant circulation line 152.

Depending on the air conditioning mode condition, the second three-way valve 164b allows or blocks communication of the portion of the battery-side coolant circulation line 152 on the downstream side of the battery 140 with the portion of the heater core-side coolant circulation line 120.

Accordingly, depending on the air conditioning mode condition, the coolant in the battery-side coolant circulation line 152 passed through the battery 140 is allowed to return, or prevented from returning, to the heater core-side coolant circulation line 120.

According to the first and second three-way valves 164a and 164b, the coolant in the heater core-side coolant circulation line 120 passed through the water-cooled heat exchanger 114 and the electric heater 122 is circulated to at least one of the heater core 130 and the battery 140 of the battery-side coolant circulation line 152 depending on the air conditioning mode condition.

Therefore, the coolant heated by the water-cooled heat exchanger 114 and the electric heater 122 can be circulated to the heater core 130, or the battery 140 of the battery-side coolant circulation line 152, or both the heater core 130 and the battery 140 of the battery-side coolant circulation line 152.

Thus, by utilizing the refrigerant heat generated in the refrigerant circulation process of the heat pump type air conditioner 100, it is possible to heat the vehicle interior and to preheat and warm the battery 140.

In addition, by using the single electric heater 122 in common, it is possible to heat the vehicle interior and to preheat and warm the battery 140.

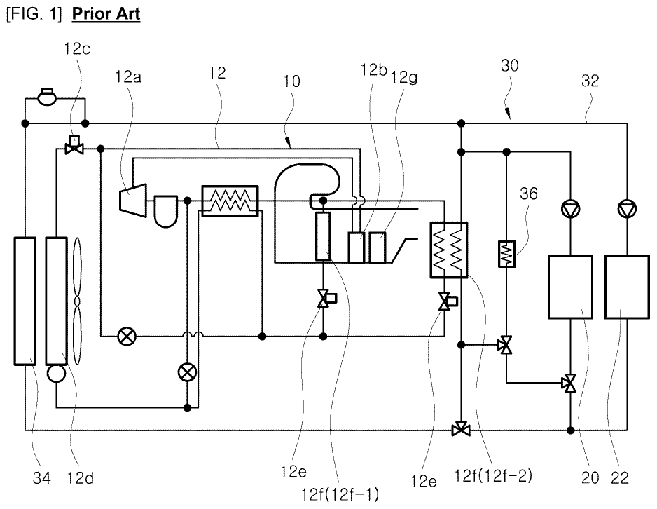

As a result, compared to the conventional technique that includes the vehicle interior heating electric heater 12g (see FIG. 1) and the battery preheating and warming electric heater 36 (see FIG. 1) and preheats and warms the battery 140 using only the electric heater 36, it is possible to save components and energy, and significantly improve the fuel efficiency and electric power efficiency of the vehicle.

Referring again to FIG. 2, the valve part 164 further includes a valve control part 164c that controls the first and second three-way valves 164a and 164b according to the air conditioning mode condition.

The valve control part 164c is equipped with a microprocessor and controls the first and second three-way valves 164a and 164b according to the air conditioning mode condition to determine whether to allow circulation of the coolant passed through the water-cooled heat exchanger 114 and the electric heater 122 toward the heater core 130, or toward the battery 140 of the battery-side coolant circulation line 152, or toward both the heater core 130 and the battery 140 of the battery-side coolant circulation line 152.

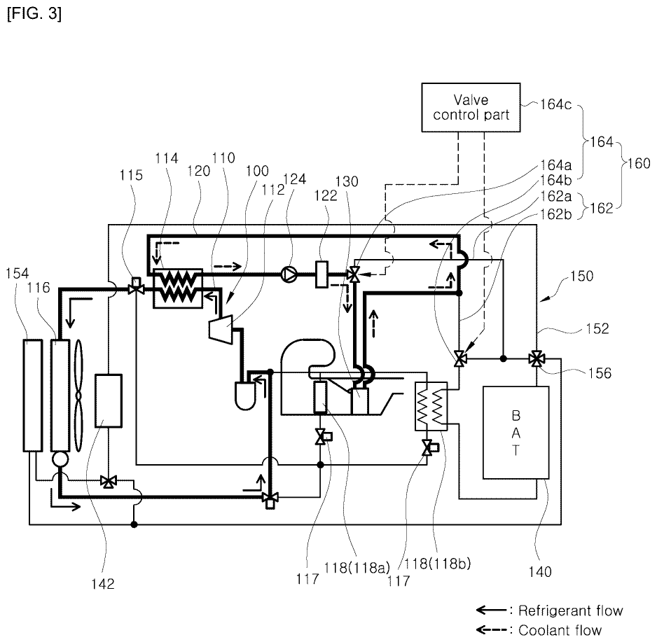

For example, as illustrated in FIG. 3, when entering the vehicle interior heating exclusive mode under the heat pump mode condition, the valve control part 164c controls the first and second three-way valves 164a and 164b to allow circulation of the coolant passed through the water-cooled heat exchanger 114 and the electric heater 122 toward the heater core 130 and to prevent circulation of the coolant toward the battery 140 of the battery-side coolant circulation line 152.

Therefore, when entering the vehicle interior heating exclusive mode under the heat pump mode condition, the coolant in the heater core-side coolant circulation line 120, which has been heated while passing through the water-cooled heat exchanger 114 and the electric heater 122, can circulate only toward the heater core 130 to heat the vehicle interior.

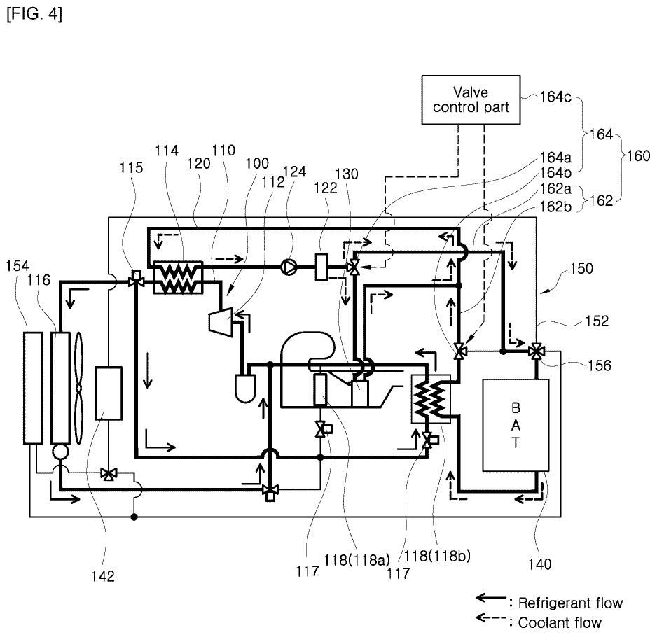

In addition, as illustrated in FIG. 4, when entering the vehicle interior heating mode and the battery warming mode simultaneously under the heat pump mode condition, the valve control part 164c controls the first and second three-way valves 164a and 164b to allow circulation of the coolant passed through the water-cooled heat exchanger 114 and the electric heater 122 toward both the heater core 130 and the battery 140 of the battery-side coolant circulation line 152.

Therefore, when entering the vehicle interior heating mode and the battery warming mode simultaneously under the heat pump mode condition, the coolant in the heater core-side coolant circulation line 120, which has been heated while passing through the water-cooled heat exchanger 114 and the electric heater 122, can be circulated to both the heater core 130 and the battery 140.

Accordingly, when entering the vehicle interior heating mode and the battery warming mode simultaneously under the heat pump mode condition, the heating of the vehicle interior and the preheating and warming of the battery 140 can be performed simultaneously.

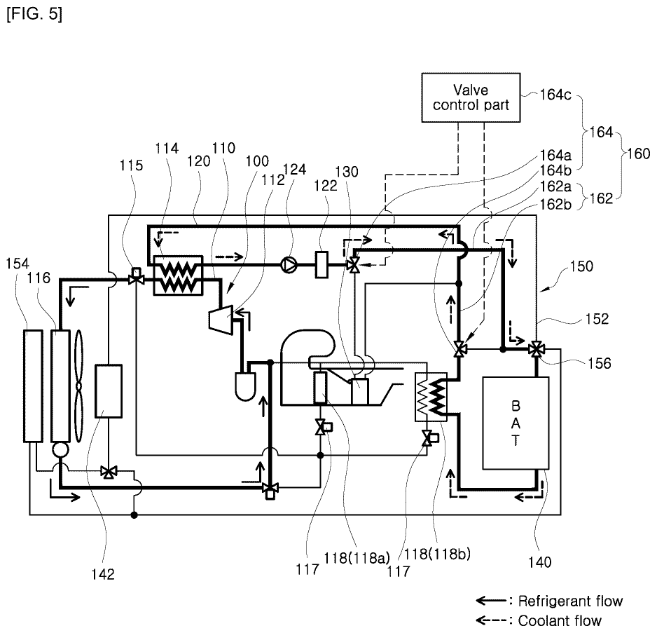

In addition, as illustrated in FIG. 5, when entering the battery warming exclusive mode under the heat pump mode condition, the valve control part 164c controls the first and second three-way valves 164a and 164b to prevent circulation of the coolant passed through the water-cooled heat exchanger 114 and the electric heater 122 toward the heater core 130 and to allow circulation of the coolant toward the battery 140 of the battery-side coolant circulation line 152.

Therefore, when entering the battery warming exclusive mode under the heat pump mode condition, the coolant in the heater core-side coolant circulation line 120, which has been heated while passing through the water-cooled heat exchanger 114 and the electric heater 122, can be wholly circulated toward the battery 140.

Thus, when entering the battery warming exclusive mode under the heat pump mode condition, the preheating and warming of the battery 140 can be performed.

When entering the vehicle interior heating mode and the battery warming mode simultaneously under the heat pump mode condition of FIG. 4, or when entering the battery warming exclusive mode under the heat pump mode condition of FIG. 5, the valve control part 164c controls a four-way valve 156 installed in the battery-side coolant circulation line 152 on the inlet side of the battery 140, so that the coolant from the water-cooled heat exchanger 114 and the electric heater 122, which are introduced toward the upstream side of the battery 140, can be introduced only to the battery 140.

In this regard, the four-way valve 156 is installed in the battery-side coolant circulation line 152 on the inlet side of the battery 140, and serves to introduce the coolant flowing upstream of the battery 140 toward the inlet of the battery 140, or toward the electrical component module 142.

The coolant flow control part 160 of the present invention can turn the electric heater 122 on or off, depending on the case.

In particular, the electric heater 122 is turned on or off, depending on the air conditioning mode condition and the temperature condition of a specific part of the vehicle.

Therefore, depending on the air conditioning mode condition and the temperature condition of a specific part of the vehicle, the coolant in the heater core-side coolant circulation line 120, which has been heated by both the water-cooled heat exchanger 114 and the electric heater 122, can be circulated toward at least one of the heater core 130 and the battery 140 of the battery-side coolant circulation line 152.

In addition, depending on the air conditioning mode condition and the temperature condition of a specific part of the vehicle, the coolant in the heater core-side coolant circulation line 120, which has been heated only by the water-cooled heat exchanger 114, can be circulated toward at least one of the heater core 130 and the battery 140 of the battery-side coolant circulation line 152.

For example, when entering the vehicle interior heating exclusive mode under the heat pump mode condition, if the vehicle interior temperature is not lower than a preset temperature, the electric heater 122 is turned off.

Therefore, when entering the vehicle interior heating exclusive mode under the heat pump mode condition, if the vehicle interior temperature is not lower than the preset temperature, the coolant in the heater core-side coolant circulation line 120 heated only by the water-cooled heat exchanger 114 can be circulated toward the heater core 130 to heat the vehicle interior.

When entering the vehicle interior heating mode and the battery warming mode simultaneously under the heat pump mode condition, if the conditions that the vehicle interior temperature is not lower than the preset temperature and the temperature of the battery 140 is not lower than the preset temperature are simultaneously satisfied, the electric heater 122 is turned off.

Therefore, when entering the vehicle interior heating mode and the battery warming mode simultaneously under the heat pump mode condition, if the conditions that the vehicle interior temperature is not lower than the preset temperature and the temperature of the battery 140 is not lower than the preset temperature are simultaneously satisfied, the coolant in the heater core-side coolant circulation line 120 heated only by the water-cooled heat exchanger 114 can be circulated toward both the heater core 130 and the battery 140, thereby heating the vehicle interior and preheating and warming the battery 140.

When entering the battery warming exclusive mode under the heat pump mode condition, the electric heater 122 is turned off under the condition that the temperature of the battery 140 is not lower than the preset temperature.

Therefore, when entering the battery warming exclusive mode under the heat pump mode condition, the coolant in the heater core-side coolant circulation line 120 heated only by the water-cooled heat exchanger 114 can be circulated toward the battery 140, thereby preheating and warming the battery 140.

With the vehicle heat management system according to the present invention, the coolant heated by the water-cooling heat exchanger 114 of the heat pump type air conditioner 100 is circulated toward the battery 140. Therefore, it is possible to preheat and warm the battery 140 using the heat generated during the refrigerant circulation process in the heat pump type air conditioner 100.

Since the vehicle interior can be heated and the battery 140 can be preheated and warmed using the heat of the refrigerant generated in the refrigerant circulation process in the air conditioner 100, it is possible to reduce the frequency of using the electric heater 122 for preheating and warming the battery 140 and consequently prevent the excessive energy consumption due to the frequent use of the electric heater 122.

Since the excessive energy consumption due to the frequent use of the electric heater 122 can be prevented, it is possible to minimize the consumption of electric power of the battery 140 and consequently improving the fuel efficiency and the electric power efficiency of the vehicle.

Since the coolant heated by the water-cooled heat exchanger 114 of the heat pump type air conditioner 100 and the electric heater 122 can be circulated toward at least one of the heater core 130 and the battery 140, it is possible to heat the vehicle interior and preheat and warm the battery 140 using the single electric heater 122 in common.

Since the vehicle interior can be heated and the battery 140 can be preheated and warmed using the single electric heater 122 in common, it is possible to reduce the number of electric heaters 122, reduce the manufacturing cost, minimize the energy consumption, and improving the fuel efficiency and electric power efficiency of the vehicle.

While the preferred embodiment of the present invention has been described above by way of example, the scope of the present invention is not limited to such a specific embodiment, and may be appropriately changed within the scope recited in the claims.

1. A vehicle heat management system, comprising:
a refrigerant circulation line configured to generate heat or cold air depending on the direction of flow of a refrigerant;
a heater core-side coolant circulation line configured to transfer the heat of the refrigerant generated in the refrigerant circulation line to a vehicle interior-side heater core to heat a vehicle interior;
a battery-side coolant circulation line configured to circulate a coolant to a battery;
a water-cooled heat exchanger configured to transfer the heat of the refrigerant generated in the refrigerant circulation line to the coolant in the heater core-side coolant circulation line;
an electric heater configured to heat the coolant in the heater core-side coolant circulation line; and
a coolant flow control part configured to circulate the coolant in the heater core-side coolant circulation line heated by at least one of the water-cooled heat exchanger and the electric heater toward at least one of the heater core and the battery of the battery-side coolant circulation line according to an air conditioning mode condition.

2. The system of claim 1, wherein the coolant flow control part is configured to, when entering a vehicle interior heating exclusive mode under a heat pump mode condition, circulate the coolant in the heater core-side coolant circulation line heated by at least one of the water-cooled heat exchanger and the electric heater toward the heater core, so that the vehicle interior can be heated by the coolant in the heater core-side coolant circulation line.

3. The system of claim 2, wherein the coolant flow control part is configured to, when entering a vehicle interior heating mode and a battery warming mode simultaneously under the heat pump mode condition, circulate the coolant in the heater core-side coolant circulation line heated by at least one of the water-cooled heat exchanger and the electric heater toward both the heater core and the battery of the battery-side coolant circulation line to heat the vehicle interior and warm the battery with the coolant in the heater core-side coolant circulation line.

4. The system of claim 3, wherein the coolant flow control part is configured to, when entering a battery warming exclusive mode under the heat pump mode condition, circulate the coolant in the heater core-side coolant circulation line heated by at least one of the water-cooled heat exchanger and the electric heater toward the battery of the battery-side coolant circulation line to warm the battery with the coolant in the heater core-side coolant circulation line.

5. The system of claim 4, wherein the coolant flow control part includes a parallel connection part configured to connect the heater core of the heater core-side coolant circulation line and the battery of the battery-side coolant circulation line in parallel with respect to the water-cooled heat exchanger and the electric heater, and a valve part configured to control the flow of the coolant so that the coolant in the heater core-side coolant circulation line, which has passed through the water-cooled heat exchanger and the electric heater, can be circulated toward at least one of the heater core and the battery of the battery-side coolant circulation line connected in parallel.

6. The system of claim 5, wherein the parallel connection part includes a first connection line configured to introduce the coolant in the heater core-side coolant circulation line, which has passed through the water-cooled heat exchanger and the electric heater, toward the battery of the battery-side coolant circulation line before being introduced toward the heater core, and a second connection line configured to return the coolant in the battery-side coolant circulation line, which has passed through the battery, to the heater core-side coolant circulation line, and the first and second connection lines connect the battery side of the battery-side coolant circulation line and the heater core side of the heater core-side coolant circulation line so as to form a parallel coolant circulation structure.

7. The system of claim 6, wherein the valve part includes a first three-way valve installed at a branch point of the heater core-side coolant circulation line and the first connection line so as to allow introduction of the coolant passed through the water-cooled heat exchanger and the electric heater toward the heater core, or toward the battery of the battery-side coolant circulation line, or toward both the heater core and the battery of the battery-side coolant circulation line, depending on the air conditioning mode condition, a second three-way valve installed at a branch point of the battery-side coolant circulation line and the second connection line so as to allow or prevent return of the coolant passed through the battery to the heater core-side coolant circulation line, depending on the air conditioning mode condition, and a valve control part configured to control the first and second three-way valves according to the air conditioning mode condition to determine whether to allow circulation of the coolant passed through the water-cooled heat exchanger and the electric heater toward the heater core, or toward the battery of the battery-side coolant circulation line, or toward both the heater core and the battery of the battery-side coolant circulation line.

8. The system of claim 7, wherein the valve control part is configured to, when entering the vehicle interior heating exclusive mode under the heat pump mode condition, control the first and second three-way valves so as to allow circulation of the coolant passed through the water-cooled heat exchanger and the electric heater toward the heater core and prevent circulation of the coolant toward the battery of the battery-side coolant circulation line, so that when entering the vehicle interior heating exclusive mode under the heat pump mode condition, the coolant in the heater core-side coolant circulation line, which has been heated while passing through the water-cooled heat exchanger and the electric heater, is circulated only to the heater core to heat the vehicle interior.

9. The system of claim 8, wherein the valve control part is configured to, when entering the vehicle interior heating mode and the battery warming mode simultaneously under the heat pump mode condition, control the first and second three-way valves so as to allow circulation of the coolant passed through the water-cooled heat exchanger and the electric heater toward both the heater core and the battery of the battery-side coolant circulation line, so that when entering the vehicle interior heating mode and the battery warming mode simultaneously under the heat pump mode condition, the coolant in the heater core-side coolant circulation line, which has been heated while passing through the water-cooled heat exchanger and the electric heater, is circulated toward both the heater core and the battery to heat the vehicle interior and warm the battery simultaneously.

10. The system of claim 9, wherein the valve control unit is configured to, when entering the battery warming exclusive mode under the heat pump mode condition, control the first and second three-way valves so as to prevent circulation of the coolant passed through the water-cooled heat exchanger and the electric heater toward the heater core and allow circulation of the coolant toward the battery of the battery-side coolant circulation line, so that when entering the battery warming exclusive mode under the heat pump mode condition, the coolant in the heater core-side coolant circulation line, which has been heated while passing through the water-cooled heat exchanger and the electric heater, is circulated only toward the battery to warm the battery.

11. The system of claim 10, wherein the battery-side coolant circulation line further includes a four-way valve configured to introduce the coolant on the upstream side of the battery toward an inlet of the battery or toward an electrical component module, and
the valve control part is configured to, when entering the vehicle interior heating mode and the battery warming mode simultaneously under the heat pump mode condition, or when entering the battery warming exclusive mode under the heat pump mode condition, control the four-way valve so that the coolant on the water-cooled heat exchanger side and the electric heater side, which is introduced toward the upstream side of the battery, can be introduced only toward the battery.

12. The system of claim 11, wherein the coolant flow control part is configured to turn the electric heater on or off according to the air conditioning mode condition and the temperature condition of a specific part of the vehicle, so that the coolant in the heater core-side coolant circulation line heated by both the water-cooled heat exchanger and the electric heater can be circulated toward at least one of the heater core and the battery of the battery-side coolant circulation line, or the coolant in the heater core-side coolant circulation line heated only by the water-cooled heat exchanger can be circulated toward at least one of the heater core and the battery of the battery-side coolant circulation line.

13. The system of claim 12, wherein the coolant flow control part is configured to, if the vehicle interior temperature is not lower than a preset temperature when entering the vehicle interior heating exclusive mode under the heat pump mode condition, turn off the electric heater so that the coolant in the heater core-side coolant circulation line heated only by the water-cooled heat exchanger can be circulated toward the heater core to heat the vehicle interior.

14. The system of claim 13, wherein the coolant flow control part is configured to, only if the vehicle interior temperature is not lower than a preset temperature and the battery temperature is not lower than a preset temperature when entering the vehicle interior heating mode and the battery warming mode simultaneously under the heat pump mode condition, turn off the electric heater so that the coolant in the heater core-side coolant circulation line heated only by the water-cooled heat exchanger can be circulated toward both the heater core and the battery to heat the vehicle interior and warm the battery.

15. The system of claim 14, wherein the coolant flow control part is configured to, if the battery temperature is not lower than the preset temperature when entering the battery warming exclusive mode under the heat pump mode condition, turn off the electric heater so that the coolant in the heater core-side coolant circulation line heated only by the water-cooled heat exchanger can be circulated toward the battery to warm the battery.
